(19) United States
(12) Patent Application Publication
(10) Pub. No.: US 2002/0136917 A1
(43) Pub. Date: Sep. 26, 2002

(54) Metallic tubular components for industrial flowstreams

(76) Inventors: Damadoran Raghu, Houston, TX (US); James B. C. Wu, St. Louis, MO (US); John C. Hebeisen, Moulton Borough, NH (US); Stephen J. Mashl, Chelmsford, MA (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/817,391

(22) Filed: Mar. 26, 2001

(51) Int. Cl. B32B 15/16; B32B 15/02

(52) U.S. Cl. 428/548; 428/937; 428/469

(57) ABSTRACT

A metallic tube for transporting corrosive, abrasive, and erosive industrial flow streams. The tube has an outer tube material consisting of consolidated metallic powder bonded to an inner tube material consisting of a corrosion- or wear-resistant, weld- or spray-deposited material. The tube has a bend in it of at least about 45°, such as a U-bend, which would normally inhibit the weld- or spray-deposition of the corrosion- or wear-resistant inner tube material.

### BACKGROUND OF THE INVENTION

This invention is directed to metallic tubular components such as tubes and pipes for directing fluids in industrial processes, with special application to segments of flow paths where the direction of flow is changed, resulting in especially harsh conditions due to turbulence resulting from the change in direction.

Tubes, including pipes, which carry industrial process flow streams suffer excessive erosive, abrasive, and corrosive wear at U-bends and other locations where the direction of flow is changed, at least in significant part due to the turbulent flow at such locations. These particular segments must therefore often be replaced more often than other segments, resulting in excessive down time and expense.

Heretofore U-bends and other sections of tubes suffering excessive wear have been lined with corrosion- or wear-resistant materials by, for example, hot extrusion, weld overlaying, or thermal spraying. Certain of the available material treatment methods cannot be used on small or bent tubes where the area to be coated is not accessible or not in a direct line of sight from openings to the tube.

### SUMMARY OF THE INVENTION

It is an object of this invention, therefore, to provide tubes, including pipes, for industrial process fluids, which tubes are made from materials resistant to especially corrosive, erosive, or abrasive conditions; and to provide such tubes in bent geometries, as necessary for particular applications.

In one aspect, therefore, the invention is directed to a metallic tube for transporting industrial flow streams, the tube comprising an outer tube material consisting of consolidated metallic powder bonded to an inner tube material consisting of deposited material.

In another aspect the invention is directed to a continuous bent metallic tube for transporting industrial flow streams, the tube having at least one bend of about 45° or more therein and comprising an outer tube material consisting of consolidated metallic powder bonded to an inner tube material consisting of deposited material.

The invention is also directed to a metallic U-bend tube for carrying industrial flow streams, the tube consisting of an inner U-bend tube segment formed by depositing metal onto a temporary metallic mold, and an outer tube segment formed by bonding material powder to the external surface of the inner tube segment.

The invention is further directed to a metallic U-bend tube for carrying highly corrosive, acidic industrial flow streams consisting of an inner tube segment formed by depositing an acid-resistant metal onto a temporary metallic mold tube by a method selected from the group consisting of thermal spraying, plasma spraying, plasma transfer arc welding, laser welding, and gas metal arc welding. There is also an outer tube segment formed by a powder metallurgical process consolidating metallic powder to form the outer tube segment and diffusion bonding the outer tube segment to the inner tube segment.

Other objects and features will be in part apparent and in part pointed out hereinafter.

### BRIEF DESCRIPTION OF THE FIGURES

FIG. 1 is a schematic illustration of the tube of the invention in cross section.

FIG. 2 is a schematic illustration in cross section of the mold tube with first tube material applied thereto.

FIG. 3 is a schematic illustration in cross section of the mold tube, first tube material, second tube material, and casing.

### DETAILED DESCRIPTION OF THE INVENTION

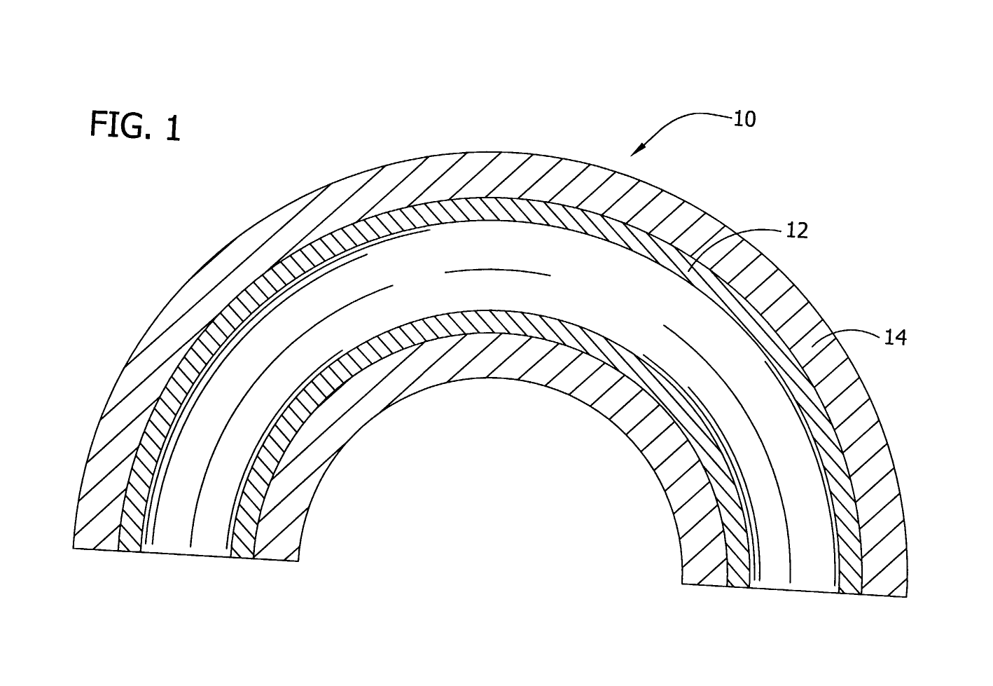

In one aspect the invention is a tube 10 shown schematically in cross section in FIG. 1 consisting of a first material 12 innermost to the axis of the tube and a second material 14 on the outside of the first material. The first tube material typically consists of a more wear resistant material and is selected for its resistance to conditions corresponding to fluid, including liquids and slurries, which flows through the tube, fluid flow rate, and other environmental parameters. A different material is used, for example, for a tube for carrying a sulfuric acid-based slurry than is used for a tube for carrying phosphoric acid. Each particular application has its own requirements for resistance to abrasion, corrosion, and erosion, which requirements are reflected in the selection of the first tube material, and in selection of the thickness of first tube material laterally with respect to the axis of the tube.

The tube also consists of a second tube material 14 which has an interface with the first tube material, and which is outside the first tube material with respect to the axis of the tube. For the most part, the second tube material has a structural function to support the first tube material.

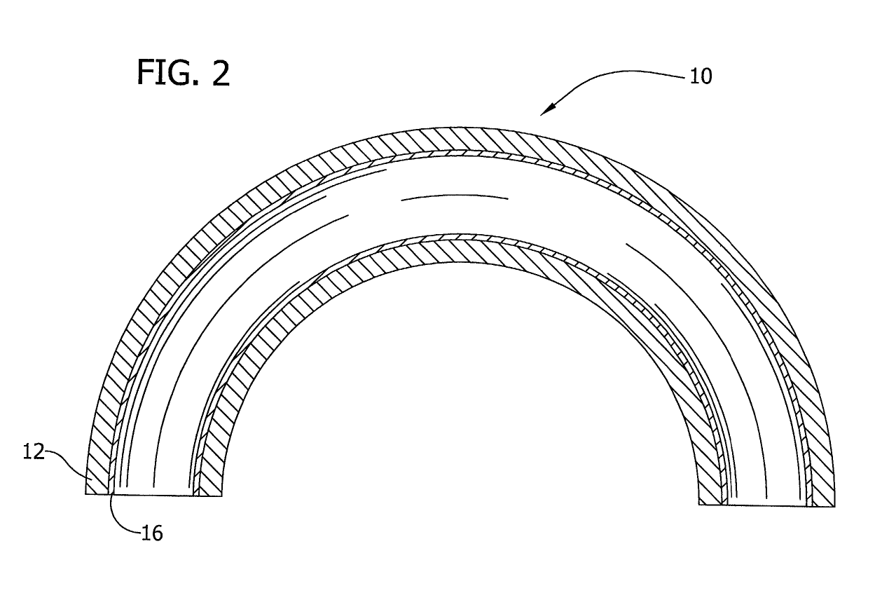

The method for manufacturing the tube is important to its structure. In accordance with this method, a sacrificial mold tube 16 (FIG. 2) is provided which approximates the internal shape and dimension of the ultimate tube to be manufactured. The mold tube provides a shape around which the tube is formed. The mold tube is of a material such as carbon steel which can be readily removed by mechanical or chemical means such as leaching after the tube is formed.

The first tube material 12, which is erosion-, abrasion-, and/or corrosion-resistant as discussed above, is applied to the external surfaces of the mold tube 16 as shown in FIG. 2. In one embodiment, the first tube material is applied using a commercially available high velocity oxy-fuel (HVOF) thermal spray method. The thickness of the first tube material applied is dictated by the requirements of the particular application. In one preferred embodiment, the first tube material is commercial available from Deloro Stellite, Inc. of Goshen, Ind. under the trademark Stellite 6 and has the following composition: 28 Cr, 4.5 W, 0.9 C, Bal. Co plus incidental impurities. In this preferred embodiment, the first tube material is applied by HVOF thermal spray to a thickness of about 0.5 to 4 mm. Other acceptable application methods include, for example, weld overlaying, wire thermal spraying, plasma spraying, plasma transfer arc welding, laser welding, and gas metal arc welding, also to a thickness of about 0.5 mm to about 4 mm.

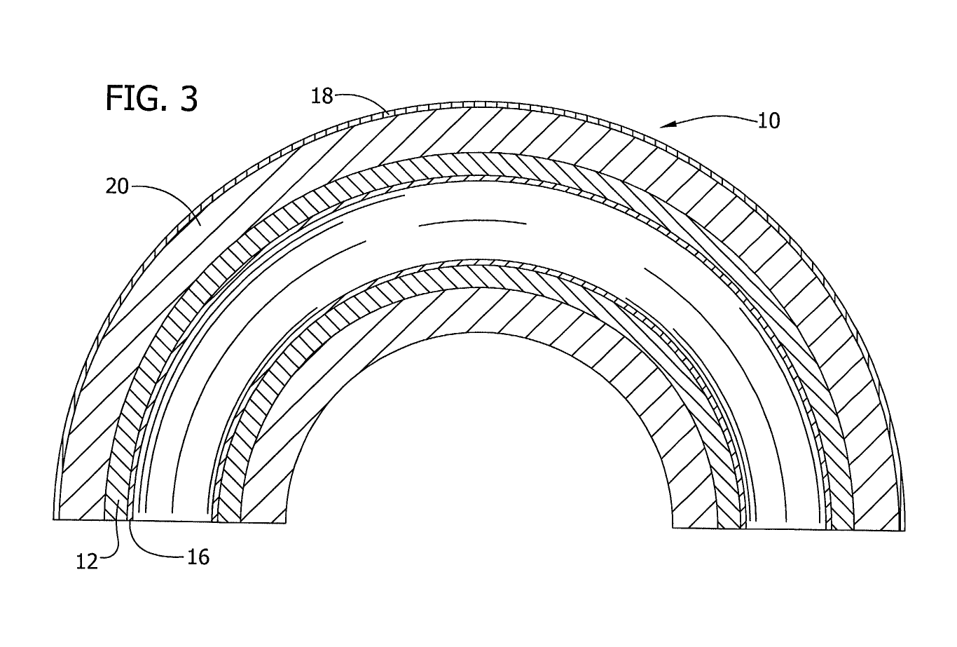

The mold tube with the first tube material thereon is placed inside a casing 18 of, for example, carbon steel, and a metal alloy powder 20 of the second tube material is packed into the void space between the first tube material and the casing, as shown in FIG. 3. In one preferred embodiment, the metal alloy powder is grade 316 stainless steel powder commercially available from Deloro Stellite, Inc. of Goshen, Ind. 316 stainless has the following composition: 18 Cr, 8 Ni, 2 Mo, 0.08 C, Fe Balance plus incidental impurities.

The metal powder 20 of the second tube material is then consolidated by sintering and diffusion bonded to the first tube material by an appropriate commercially available method. In one preferred embodiment, this is accomplished by the well known sintering process called hot isostatic pressing (HIP). While the second tube material powder consolidates, so does the first tube material, as its pores close and otherwise the material is consolidated. Therefore, HIP parameters of time, temperature, and pressure are selected which result in consolidation of both materials while avoiding melting of both materials. The entire composite of sacrificial mold tube 16, first tube material 12, second tube material 20, and casing 18 are placed in the HIP furnace. Diffusion between the first and second tube materials creates a strong metallurgical bond therebetween. The consolidation process, be it HIP or otherwise, further serves to enhance the integrity of first tube material and close pores therein.

If conventional vacuum sintering is employed, a wax or other binder is incorporated into the powder of the second material.

After consolidation, the casing 18 is removed. The sacrificial mold tube 16 is then removed by mechanical or chemical means, such as by machining or by acid leaching. The surfaces of the tube, especially the internal surfaces, are then optionally surface treated as by cleaning, machining, polishing, or other surface treatment method as is appropriate under the circumstances to yield a final product as shown in FIG. 1 having the desired surface characteristics. This yields a composite tube comprising the first tube material 12 forming the inner surface of the tube and the second tube material 14 forming the outer surface of the tube.

Among the further advantages of the present invention is that the first tube material is metallic or optionally cermet or optionally ceramic, because it can be deposited by a wide variety of methods including plasma spraying which are compatible with metallic as well as non-metallic materials. This flexibility in coating method also permits deposition of thicker coatings. It also permits selection of a method such as plasma spraying, which gives a smoother coating than traditional welding deposition techniques. This is important because a smoother coating reduces turbulence inside the tube, which is a significant factor in component life. Also, as compared to conventional manufacture of coated tubing, the HIPping reduces defects.

As various changes could be made in the above embodiment without departing from the scope of the invention, it is intended that all matter contained in the above description shall be interpreted as illustrative and not in a limiting sense.

1. A metallic tube for transporting industrial flow streams, the tube comprising an outer tube material consisting of consolidated metallic powder bonded to an inner tube material consisting of deposited material.

2. The metallic tube of claim 1 wherein the inner tube material is selected from the group consisting of cermets, ceramics, and metals, and is deposited by a method selected from the group consisting of material spraying and metal welding deposition techniques.

3. The metallic tube of claim 1 wherein the inner tube material is deposited by a method selected from the group consisting of thermal spraying, plasma spraying, plasma transfer arc welding, laser welding, gas metal arc welding.

4. The metallic tube of claim 1 wherein the inner tube material has enhanced resistance to industrial conditions selected from the group consisting of erosion, abrasion, and corrosion.

5. The metallic tube of claim 3 wherein the inner tube material has enhanced resistance to industrial conditions selected from the group consisting of erosion, abrasion, and corrosion.

6. A continuous bent metallic tube for transporting industrial flow streams, the tube having at least one bend of about 45° or more therein and comprising an outer tube material consisting of consolidated metallic powder bonded to an inner tube material consisting of deposited material.

7. The metallic tube of claim 6 wherein the inner tube material is selected from the group consisting of metal, cermet, and ceramic and is deposited by a method selected from the group consisting of metal spraying and metal welding deposition techniques.

8. The metallic tube of claim 6 wherein the inner tube material is selected from the group consisting of metal, cermet, and ceramic and is deposited by a method selected from the group consisting of thermal spraying, plasma spraying, plasma transfer arc welding, laser welding, and gas metal arc welding.

9. The metallic tube of claim 6 wherein the inner tube material has enhanced resistance to industrial conditions selected from the group consisting of erosion, abrasion, and corrosion.

10. The metallic tube of claim 7 wherein the inner tube material has enhanced resistance to industrial conditions selected from the group consisting of erosion, abrasion, and corrosion.

11. The metallic tube of claim 7 comprising a U-bend.

12. The metallic tube of claim 9 comprising a U-bend.

13. The metallic tube of claim 8 wherein the inner tube segment is formed by deposition onto a temporary metallic mold.

14. A metallic U-bend tube for carrying industrial flow streams, the tube consisting of an inner U-bend tube segment formed by depositing metal onto a temporary metallic mold, and an outer tube segment formed by bonding material powder to the external surface of the inner tube segment.

15. The metallic U-bend tube of claim 14 wherein the inner tube material is selected from the group consisting of metal, cermet, and ceramic, and is deposited by a method selected from the group consisting of metal spraying and metal welding deposition techniques.

16. The metallic tube of claim 14 wherein the inner tube material is selected from the group consisting of metal, cermet, and ceramic and is deposited by a method selected from the group consisting of thermal spraying, plasma spraying, plasma transfer arc welding, laser welding, and gas metal arc welding.

17. The metallic tube of claim 14 wherein the inner tube material has enhanced resistance to industrial conditions selected from the group consisting of erosion, abrasion, and corrosion.

18. A metallic U-bend tube for carrying highly corrosive, acidic industrial flow streams consisting of:
an inner tube segment formed by depositing an acid-resistant metal onto a temporary metallic mold tube by a method selected from the group consisting of thermal spraying, plasma spraying, plasma transfer arc welding, laser welding, and gas metal arc welding, and
an outer tube segment formed by a powder metallurgical process consolidating metallic powder to form the outer tube segment and diffusion bonding the outer tube segment to the inner tube segment.
